(19) United States
(12) Patent Application Publication
(10) Pub. No.: US 2003/0109646 A1
(43) Pub. Date: Jun. 12, 2003

(54) Resin composition and method of producing shaped articles

(75) Inventors: Katsuyoshi Kubo, Rye, NY (US); Takahide Otsuka, Yardley, PA (US); Masahiko Oka, Mahwah, NJ (US); Charles W. Stewart, Newark, DE (US); Carolyn Stewart, Newark, DE (US)

Correspondence Address: SUGHRUE MION, PLLC, 2100 Pennsylvania Avenue, N.W., Washington, DC, 20037-3213, US

(73) Assignee: DAIKIN INSTITUTE OF ADVANCED CHEMISTRY AND TECHNOLOGY

(21) Appl. No.: 09/989,160

(22) Filed: Nov. 21, 2001

(51) Int. Cl. C08L 77/00

(52) U.S. Cl. 525/420

(57) ABSTRACT

A resin composition prepared by formulating an engineering plastic with a fluorine-containing polymer in a mass ratio of the engineering plastic to the fluorine-containing polymer of from 99:1 to 99.995:0.005. Also disclosed is a method for producing a shaped article by melting and molding the resin composition.

### FIELD OF THE INVENTION

The present invention relates to a resin composition conducive to improved molding processability of engineering plastics, and to a method of producing shaped articles using the resin composition.

### BACKGROUND OF THE INVENTION

A moldable polymer is generally formed into a shaped article by melting at an elevated temperature in an extruder, molding the resulting melt by means of a metal mold or die, and cooling the melt. The molding technology includes but is not limited to extrusion molding, in which the molten material is transported by a revolving screw within the barrel of an extruder to a die for molding.

In such polymer molding, the extrusion pressure and extrusion torque usually increase with an increase in friction between the molten material and the die for polymers having the same melt-fluidity. An excessively high extrusion pressure or extrusion torque overloads the extruder and may cause problems in commercial production, such as an automatic stop of the extruder.

Furthermore, in polymer molding, if the extrusion pressure or extrusion torque is not constant but changes unexpectedly, problems will be encountered in that the resulting shaped article tends to be defective in surface smoothness or gloss, for instance. The result is that it becomes difficult to supply products of consistently acceptable quality, or product yield and productivity are sacrificed.

For the purpose of improving polymer molding processability, there have been proposals to add a processing aid to the polymer. As such a processing aid, a fluorine-containing polymer in low concentration is known to be useful in alleviating adverse events such as the incidence of melt fracture or high torque which limits the polymer extrusion speed.

U.S. Pat. No. 5,010,130 describes an auxiliary agent-blended resin composition comprising, as a main component, a hardly melt-moldable resin and, as another component, polytetrafluoroethylene (PTFE) having a viscosity of 400 Pa.s at 200° C., or a tetrafluoroethylene (TFE) copolymer melting at a molding temperature in the case of a crystalline resin or having a Tg not less than the molding temperature in the case of a non-crystalline resin. However, this technology is directed to resins which can be hardly melt-molded, and the fluororesin is said to be a resin having a melting point not higher than the melting point of the main resin.

U.S. Pat. No. 3,125,547 discloses the use of a small quantity of a fluorocarbon polymer as a continuous-feed slip agent in the extrusion molding of a hydrocarbon polymer such as low-density polyethylene (LDPE), and comments that the fluororesin which is solid at the processing temperature does little or nothing to improve the extrusion characteristics of hydrocarbon polymers.

U.S. Pat. No. 4,855,360 discloses a thermoplastic olefin resin composition comprising a poly(oxyalkoxy)olefin for improving flow on the die surface to reduce melting defects in the extrudate. A fluororesin is incorporated in a weight ratio of 1/1 to 1/10 relative thereto, or in a proportion of 0.005 to 0.2 wt. % relative to the polyolefin resin composition.

U.S. Pat. No. 4,904,735 discloses a technology in which a fluororesin which is molten in the case of a crystalline resin or exceeds Tg in the case of a non-crystalline resin at a molding temperature is incorporated into a hardly melt-moldable resin comprising at least one monoolefin resin such as LDPE.

U.S. Pat. No. 5,266,639 discloses a technique of using a TFE/hexafluoropropylene (HFP) copolymer (FEP) having a specific infrared ratio (HFP index) of 6.4 to 9.0 and a melt viscosity of 0.1×10³ to 10×10³ poise as a polyolefin-molding aid for preventing melt fracture and retrenching the molding start time.

U.S. Pat. No. 5,464,904 discloses a technique of blending a polyolefin resin with a fluororesin having a hydrogen atom content of not more than 2 wt %, a melt viscosity of 0.1×10³ to 10×10³ poise, and a melting end temperature (Tm) of 170 to 265° C.

U.S. Pat. No. 5,547,761 discloses a technique of coating a polyolefin with an FEP having an HFP index of 6.4 to 9.0 and a Tm value of 180 to 255° C.

U.S. Pat. No. 5,707,569 discloses a technique of formulating a fluororesin in the process for extrusion-molding a polyolefin composition comprising a bivalent or trivalent metal ion and an organic or inorganic anion for the purpose of eliminating the effect of Ca²⁺.

However, these techniques are only relevant to polyolefin polymers obtained by vinyl polymerization, such as polyethylene, polypropylene or the like, and none of the literature teaches a technique using a fluorine-containing polymer for the purpose of improving the molding processability of engineering plastics such as polyamides and polyetheretherketones.

U.S. Pat. No. 5,132,368 discloses a composition including a hardly melt-processable polymer and, based on the polymer, 0.002˜0.5 wt % of a fluoropolymer processing aid, citing a formulation comprising nylon 66 and FEP or irradiated PTFE as an example. However, this fluoropolymer has at least 100 units of a specified polar functional group, such as ionic groups, e.g., —COOH and —SO₃H, and/or —COF or the like, per 10⁶ carbon atoms at the chain terminus. This patent publication comments that the processing aid is bound to the metal or metal oxide die surface chemically or physically to reduce the resistance to flow of the polymer melt on the die surface, that this additive no longer functions as an effective processing aid when the polar terminal groups become nonexistent by a treatment such as moist heat treatment, and that the die pressure and variation thereof cannot be decreased at this fluoropolymer concentration. Therefore, this technique is different from the present invention with respect to the characteristics of fluorine-containing polymer and the effect of the invention. This technique allows a slip layer to persist on the metal or the like by virtue of the polar functional groups over an extended period of the molding process, while the reactivity to the hardly melt-processable polymer is also increased to cause added friction so that the extrusion pressure cannot be sufficiently depressed.

### SUMMARY OF THE INVENTION

It is therefore an object of the present invention to provide a resin composition which, in the molding of meltable engineering plastics, as distinguished from the hardly melt-moldable resins or polyolefin resins treated in the above prior art patent publications, is conducive to improved molding processability in consideration of extrusion pressure, extrusion torque and other process parameters, and which further insures stable molding processability in consideration of extrusion pressure, extrusion torque and the like.

The above objects of the present invention are achieved by providing a resin composition prepared by formulating an engineering plastic with a fluorine-containing polymer at a mass ratio of said engineering plastic to said fluorine-containing polymer of from 99:1 to 99.995:0.005.

The fluorine-containing polymer of the present invention is preferably a polymer containing tetrafluoroethylene as a monomer component or a perfluoropolymer. The engineering plastic is preferably a polyamide or a polyetheretherketone. The resin composition is preferably adapted for use as a molding material. The present invention is further directed to a method of producing a shaped article by meting and molding the above resin composition. The present invention is now described in further detail below.

### DETAILED DESCRIPTION OF THE INVENTION

The resin composition of the invention is prepared by formulating a fluorine-containing polymer with an engineering plastic.

The fluorine-containing polymer is a polymer having fluorine atoms bound to some or all of the carbon atoms constituting the backbone chain of the polymer. Such fluorine-containing polymers include polymers obtained by polymerizing, as a monomer component, one or more than one fluorine-containing monomers, for example perfluoromonomers such as tetrafluoroethylene (TFE), hexafluoropropylene (HFP), perfluoro(alkyl vinyl ether) (PAVE); chlorofluorovinyl monomers, e.g., chlorotrifluoro-ethylene (CTFE); other fluorine-containing vinyl monomers, e.g., vinylidene fluoride (VdF), vinyl fluoride, trifluoroethylene and the like. The above monomer component may further contain one or more non-fluorine-containing vinyl monomers such as ethylene (Et), propylene (Pr), or the like.

The perfluoromonomer mentioned above is a monomer having a main chain composed of carbon and fluorine and, in some cases, oxygen as well, with no hydrogen atom bound to the main chain carbon atom, thus including perfluorovinyl monomers such as TFE, HFP, etc., and also inclusive of PAVE monomers such as perfluoro(propyl vinyl ether) (PPVE). The oxygen atom is usually ether oxygen.

In terms of molecular structure, the fluorine-containing polymer includes but is not limited to perfluoropolymers such as polytetrafluoroethylene (PTFE), TFE/HFP copolymer (FEP), TFE/PAVE copolymer (PFA) and the like. The above perfluoropolymers are polymers obtained by polymerizing any of these perfluoromonomers as the monomer component to the exclusion of other types of monomer components. PTFE, mentioned above, includes low-molecular-weight PTFE generally having an average molecular weight of not more than 100,000 and PTFE having a core-shell structure as described in JP Kokai H4-154842 and JP Kokai H5-279579, among others.

The fluorine-containing polymer further includes VdF series polymers containing VdF as a monomer component, such as polyvinylidene fluoride (PVdF), TFE/HFP/VdF copolymer (THV), VdF/TFE copolymer (VT), VdF/HFP copolymer (VdF/HFP), VdF/TFE/HFP copolymer (VdF/TFE/HFP) and the like.

The fluorine-containing polymer further includes other TFE series polymers such as Et/TFE copolymer (ETFE), Et/TFE/HFP copolymer (EFEP), etc.; and Et/CTFE copolymer (ECTFE), among others. Here, the other TFE series polymers are polymers obtained by polymerization of monomer components including TFE, and do not include perfluoropolymers or VdF series polymers.

The fluorine-containing polymer may comprise one that is obtained by polymerizing, in addition to comonomers essential to the above-mentioned copolymers, one or more minor comonomers such as fluorine-containing monomers; non-fluorine-containing vinyl monomers such as Et, Pr, etc.; and monomers having hydroxyl, carbonyl or other functional groups, and even monomers having cyclic structures. The cyclic structure includes but is not limited to cyclic ether structures such as cyclic acetal structures, preferably such that at least two carbon atoms constituting a cyclic ether structure are part of the main chain of the fluorine-containing polymer.

The fluorine-containing polymer obtained by copolymerizing a minor proportion of comonomers in addition to comonomers essential to the above-mentioned comonomers includes but is not limited to FEP obtained by copolymerizing a small amount of PAVE such as PPVE, and the like.

The comonomer to be copolymerized as a minor comonomer component is preferably used in a proportion of not more than 0.5 wt % based on the total amount of the monomer component. If the proportion exceeds 0.5 wt %, the objective copolymer characteristics may not be expressed.

The fluorine-containing polymer mentioned above may be a perfluoropolyether. The perfluoropolyether is not particularly limited and includes perfluoropolyethers having one or more than one kind of straight-chain or branched-chain perfluoro(polyoxyalkylene) groups of the following general formulae:

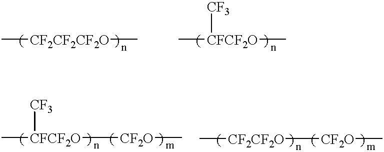

(where n represents an integer of 2 to 200, and m represents an integer of 2 to 200).

The coefficient n is preferably an integer of 5 to 50. The coefficient m is preferably an integer of 5 to 50.

The fluorine-containing polymer may also be a fluorine-containing multi-segmented polymer or a thermoplastic fluororubber. The fluorine-containing multi-segmented polymer is a polymer consisting of at least one elastomeric fluorine-containing polymer chain segment and at least one non-elastomeric fluorine-containing polymer chain segment both linked as a block or graft to a polymer molecule.

The technology of coupling the elastomeric segment and the non-elastomeric segment as a block or a graft to obtain a fluorine-containing multi-segmented polymer includes a method of producing a block-type fluorine-containing multi-segmented polymer as described in JP Kokoku S58-4728 and other literature, and the method of producing a graft-type fluorine-containing a multi-segmented polymer as described in JP Kokai S62-34324.

From the standpoint of meltability, elasticity and application, etc., the above-mentioned fluorine-containing polymer may be a non-melt-moldable fluororesin such as PTFE; a melt-moldable fluororesin such as FEP, PFA, ETFE, ECTFE, EFEP, PVdF, THV, VT or the like; a fluorine-containing elastomer; or a fluorinated oil.

The fluorine-containing elastomer above is an elastomer in which fluorine atoms are bound to all or some of the carbon atoms constituting the main chain. As used herein, the term “elastomer” means one which does not have a melting point but has a glass transition point of not higher than 5° C.

The fluorine-containing elastomer is not particularly limited and includes perfluoroelastomers such as TFE/PAVE copolymer; VdF series elastomers such as VdF/HFP, VdF/TFE/HFP, etc.; and perfluoromonomer/vinyl monomer copolymers such as TFE/Pr copolymer, HFP/Et copolymer and the like.

The perfluoroelastomer is a subclass of elastomeric species among said perfluoropolymers, and the VdF series elastomer is a subclass of elastomeric species among the VdF series polymers. Preferred, among the fluorine-containing elastomers mentioned above is a perfluoroelastomer.

The fluorinated oil mentioned above is an oily substance or grease in which fluorine atoms are bound to all or some of the carbon atoms constituting the main chain. The fluorinated oil is not particularly limited and includes perfluoropolyethers.

The fluorine-containing polymers can be used independently or in combination.

The fluorine-containing polymer is preferably a perfluoropolymer, the other TFE series polymer, ECTFE, or a VdF series polymer which is a resin, more preferably a perfluoropolymer, still more preferably a perfluoropolymer which is a melt-moldable fluororesin, and most preferably FEP or PFA.

Though it depends on the end use, the fluorine-containing polymer may contain TFE as a monomer component for improving the moldability of the resin composition of the invention, and is preferably a polymer containing TFE as a monomer component that is a resin. The polymer containing TFE as a monomer component includes PTFE.

The fluorine-containing polymer preferably has, at the terminus of the main chain or in a side chain, a few polar functional groups that may be reactive to the above engineering plastics. The polar functional group that is reactive to engineering plastics is not particularly limited and includes polar functional groups such as —COF, —COOM, —SO₃M and —OSO₃M. In the above formulae, M represents a hydrogen atom, a metal cation or a quaternary ammonium ion. More preferably, the fluorine-containing polymer contains substantially no polar functional group that is reactive to engineering plastics.

As used herein, the term “having substantially no polar functional group” means that any such polar functional group, if present at the terminus of the main chain or as a side chain, is present only in a small number of an order not enabling it to express its inherent function and not reacting with engineering plastics. The number of such polar functional groups present per 10⁶ carbon atoms in the fluorine-containing polymer is not more than 50, preferably not more than 30, and more preferably not more than 10.

Because of the very fact that the fluorine-containing polymer has substantially no polar functional group that reacts with engineering plastics, the hydrolysis or other reaction of the engineering plastic in preparing the resin composition of the invention or in the course of molding, which will be described below, can be inhibited. As a result, the inherent characteristics of the engineering plastic can be fully exploited.

Since the fluorine-containing polymer has substantially no polar functional group, this fluorine-containing polymer reduces the friction between the engineering plastic and the surfaces of the die, screw and barrel of an extruder, for instance, thus exhibiting a lubricating action. Hence, extrusion pressure, extrusion torque and the variation of these parameters is reduced, consequently facilitating molding-processability of the resin composition of the invention.

The mechanism of this reduction of friction is not fully clear but is considered to be as follows. Within a molding machine, the engineering plastic has in many cases polar moieties such as amide bonds in the main chain structure thereof, and such engineering plastics are highly adhesive to metal or metal oxide members which are at the surfaces of part of the molding machine, such as a die, screw and barrel, for instance. However, because the fluorine-containing polymer having very low adhesivity in the main chain structure and substantially no polar functional group of the type described above is interposed between the engineering plastic and the metal or the like members, the adhesion between the resin composition and molding machine is reduced.

While the fluorine-containing polymer has substantially no polar functional group, it is present on the metal or metal oxide members of the internal surfaces of the molding machine to exhibit a lubricating effect on the flow of the engineering plastic throughout molding. It is by surface tension that the fluorine-containing polymer is present on the metal or metal oxide surface, and it is considered attributable to the force of one component of a phase separation system to diminish the interface with the other component as much as possible. Therefore, provided that it is steadily supplied, the fluorine-containing polymer need not have polar functional groups of its own.

The number of such polar functional groups available in the fluorine-containing polymer can be determined, for example, by the method described in U.S. Pat. No. 5,132,368. Thus, the absorbance of the film obtained by compression-molding of the fluorine-containing polymer may be determined with an infrared spectrophotometer. From this value of absorbance and the calibration factors (CF) determined by measuring model compounds containing the above polar functional groups, the number of end groups per 10⁶ carbon atoms in the fluorine-containing polymer can be calculated by means of the following equation.

(the number of polar functional groups per 10⁶ carbon atoms)=(absorbance)×(CF)×(thickness of polymer film)⁻¹

Regarding the wavelength values (em) of the polar functional groups and the corresponding calibration factors determined with model compounds, the following figures can be mentioned by way of example: —COF=5.31 μm, 406; —COOH=5.52 μm, 335; and —COOCH₃=5.57 μm, 368.

The fluorine-containing polymer can be synthesized by polymerizing the monomeric material by conventional polymerization techniques such as emulsion polymerization, suspension polymerization, solution polymerization, block polymerization, or gas-phase polymerization.

The polymerization reaction is optionally carried out in the presence of a chain transfer agent. The chain transfer agent mentioned above is not particularly limited but includes hydrocarbons such as isopentane, n-pentane, n-hexane, cyclohexane, etc.; alcohols such as methanol, ethanol, etc.; and halogenated hydrocarbons such as carbon tetrachloride, chloroform, methylene chloride, methyl chloride, etc.; although methanol is particularly preferred.

The chain transfer agent mentioned above may be used with advantage for insuring that the fluorine-containing polymer will have substantially no polar functional group. Aside from the above method, the following alternative method can be mentioned. Thus, in the case of emulsion polymerization, a polymer terminating in the polar functional group is first obtained, but such polar functional groups can be eliminated by subjecting the polymer to water vapor treatment, for instance, to stabilize the chain ends. In suspension polymerization, a polymer having substantially no polar functional groups can be obtained without resort to such treatment.

The melting point of said fluorine-containing polymer is not particularly limited, but is preferably a temperature below the melting point of the engineering plastic to be used. This is because the polymer preferably has already been melted when the engineering plastic to be used melts in a molding machine.

The engineering plastic formulated together with the fluorine-containing polymer in the resin composition of the invention is usually a substance having excellent heat resistance, high strength and high dimensional stability and which can be used as a substitute for metal in some instances, thus including various resins which can be used as materials for machines, machine component parts, electrical/electronic parts, etc., which are required to have good mechanical and other dynamic properties.

The engineering plastic has a heat resistance value of not less than 100° C., a tensile strength of not less than 5 kgf·mm⁻², and a flexural modulus of not less than 200 kgf·mm⁻². Materials devoid of such characteristics cannot be used with advantage in the ordinary uses for engineering plastics, where mechanical strength at high temperature is required.

The “heat resistance value of not less than 100° C.” means that the melting point or glass transition point of a material is not below 100° C. and that no attenuation of mechanical strength takes place at temperatures below 100° C. The engineering plastic generally has a heat resistance value of not less than 150° C., including those species called special engineering plastics or super engineering plastics.

The tensile strength mentioned above is the maximum tensile stress at break, and is the value found by dividing the maximum load by the initial sectional area of the testpiece. In this specification, the tensile strength is a value determined by the method directed in ASTM D 638-00 (2000). The engineering plastic generally has a tensile strength within the range of 5 to 20 kgf·mm⁻² in terms of the value generated for the raw, unreinforced resin material.

The flexural modulus mentioned above is the modulus calculated from the load-deflection curve constructed for a testpiece in 3-point and 4-point bending tests. In the context of this specification, flexural modulus is a value determined by the method directed in ASTM D 790-00 (2000). The engineering plastic generally has a flexural modulus in the range of 200 to 700 kgf·mm⁻² as determined for a raw, unreinforced resin material.

The resin composition of the invention is used for the melt-molding described hereinafter and, as such, is naturally a thermoplastic resin.

The engineering plastic is generally a plastic obtained by polycondensation or ring-opening polymerization, such as polyamide (PA), polyester or polyether; a plastic obtained by the carbonyl polymerization of formaldehyde or the like, such as polyoxymethylene (POM); or a certain kind of vinyl polymer which is described hereinafter.

The engineering plastic is not particularly limited insofar as it has the above-mentioned properties, thus including PAs such as nylon 6, nylon 11, nylon 12, nylon 46, nylon 66, nylon 610, nylon 612, nylon MXD6, etc.; polyesters such as polyethylene terephthalate (PET), polybutylene terephthalate (PBT), polyarylates, aromatic polyesters (including liquid crystal polyesters), polycarbonates (PC), etc.; polyacetals such as POM; other polyethers such as polyphenylene oxide (PPO), modified polyphenyleneether, polyetheretherketone (PEEK), fliran resin, etc.; polyamideimides (PAI) such as polyaminobismaleimide etc.; polysulfone resins such as polysulfone (PSF), polyethersulfone (PES), etc.; certain kinds of vinyl polymers such as ABS resin, poly-4-methylpentene-1 (TPX resin), etc.; polyphenylene sulfide (PPS); polyketone sulfides; polyetherimides; and polyimides (PI), among others. The nylon MXD6 mentioned above is a crystalline polycondensate obtained from m-xylenediamine (MXD) and adipic acid. Particularly preferred are PA and PEEK.

The above engineering plastic can be used independently or in a combination of two or more species.

Depending on their kinds, the engineering plastics can each be synthesized by known techniques.

The mass ratio of the engineering plastic to the fluorine-containing polymer is 99:1 to 99.995:0.005 as the engineering plastic: the fluorine-containing polymer. When the mass ratio of the engineering plastic to the fluorine-containing polymer is less than 99.995:0.005, reductions in extrusion pressure and extrusion torque are insufficient, while when the mass ratio exceeds 99:1, the shaped article thus obtained may develop opacity or white turbidity in the engineering plastic. Moreover, the effect of the fluorine-containing monomer is not commensurate with an excessively increased amount, thus leading to economic disadvantage. The preferred proportion is 99.99:0.01 to 99.5:0.5.

The combination of the engineering plastic and the fluorine-containing polymer is not particularly limited, but preferably includes PTFE, FEP, PFA and/or ETFE with nylon 66; PTFE, FEP, PFA and/or ETFE with nylon 46; and PTFE, FEP, PFA and/or ETFE with PEEK. Among them, more preferred are combinations of PTFE and/or FEP with nylon 66; PTFE and/or FEP with nylon 46; and PTFE and/or FEP with PEEK.

The resin composition of the invention may have other components in addition to the fluorine-containing polymer and the engineering plastic. Such other components are not particularly limited but may be a reinforcing material such as a glass fiber, asbestos fiber, carbon fiber, other high-strength fiber, glass powder; stabilizer; lubricating agent; pigment; and/or other additives.

The technology of producing the resin composition of the invention is not particularly limited but includes hitherto-known methods. A typical method comprises formulating the fluorine-containing polymer and the engineering plastic in the formulating ratio mentioned above, optionally adding the other components, and melt-kneading the mixture optionally under heating.

In the formulating step, the other components may be blended with the fluorine-containing polymer and/or the engineering plastic in advance, or added at the time of mixing the fluorine-containing polymer and the engineering plastic.

The above fluorine-containing polymer and engineering plastic should exist in a ratio within the above-mentioned range at the time when the resin composition is molded at the latest. Therefore, the formulating method includes but is not limited to a method which comprises blending the fluorine-containing polymer with the engineering plastic in a ratio within the above-mentioned range from the beginning. Another typical formulating method is a serial method which comprises formulating the fluorine-containing polymer, engineering plastic and optional other components to prepare a composition (1) in which the proportion of the fluorine-containing polymer is higher than the range mentioned above, and then supplementing this composition (1) with a further amount of the engineering plastic before or at the molding stage so as to give a composition (2) in which the ratio of the engineering plastic to the fluorine-containing polymer falls within the above-defined range.

In the latter serial method, the composition (1) is sometimes called a master batch and the formulating ratio of the engineering plastic to the fluorine-containing polymer in composition (1) is preferably more than 99.995:0.005 and not more than 80:20, more preferably within the range of 98:2 to 90:10. The above composition (2) is sometimes called “a premix”.

The blending method is not particularly limited but, for example, a mixer such as a mill which is commonly used for production of resin compositions, such as molding compositions, can be used under conventional operating conditions. Here, when particles of the fluorine-containing polymer are uniformly dispersed between and among particles of the engineering plastic, the molding processability of the resulting resin composition of the invention tends to be improved more prominently through reductions in extrusion torque and extrusion pressure, among other effects. Therefore, sufficient blending of the components is preferred, such that the particles of the fluorine-containing polymer are almost uniformly adhered to the surface of each particle of the engineering plastic.

The term “formulating” as used herein means blending the engineering plastic and the fluorine-containing polymer or preparing a master batch prior to preparation of a premix. The formulating may be conducted by melting the engineering plastic and/or the fluorine-containing polymer (melt-kneading), or by blending these materials with a mil and the like without melting. The engineering plastic and the fluorine-containing polymer may independently be in the form of pellets, granules or a powder. It is preferable, however, so as to allow the fluorine-containing polymer to be present efficiently and uniformly on the surface of the (pellets of the) engineering plastic, the engineering plastic is in the form of pellets, and the fluorine-containing polymer is in the form of powder. In this case, blending is preferably conducted without melting the engineering plastic and the fluorine-containing polymer.

The above-described preferred formulating allows the fluorine-containing polymer to be present at the interface between the engineering plastic and molding machine more efficiently than formulating by melt-kneading or blending the engineering plastic and the fluorine-containing polymer both in the form of a powder without melting, or blending the engineering plastic and the fluorine-containing polymer both in the form of pellets without melting.

The engineering plastic and the fluorine-containing polymer may be of any desired form, for example, powders, granules or pellets. Typically, the engineering plastic may be in the form of pellets, and the fluorine-containing polymer may be in the form of pellets or a powder. The fluorine-containing polymer is preferably in the form of a powder because it is easy to mix sufficiently and uniformly.

As a result, in the molding of the resin composition of the invention, it is considered that particularly in the stage where the resin composition begins to melt down to the stage where the molten mass is molded, particles of the fluorine-containing polymer adhering to the surface of particles of the engineering plastic are present in large number on the internal surface of the machine in contact with the resin composition. Thus, a sufficient lubrication effect is expressed to enable the resin composition to travel smoothly within the molding machine. As a result, it is also considered that favorable effects on processability such as drastic reductions in extrusion torque and extrusion pressure are realized.

The internal surface of the machine with which the resin composition contacts as mentioned above is, taking an extruder as an example, the surfaces of the screw in the melt-extrusion zone, the barrel surrounding and housing the screw, and the die at the extruder tip.

After or along with the blending, the composition may be melted by heating and kneading. Generally, this heating is preferably carried out at a temperature at or higher than the melting point of the engineering plastic so that while the engineering plastic is held in a molten condition, particles of the fluorine-containing polymer may be uniformly dispersed in the melt.

In the pellets available on cooling after the above melt-kneading operation, the fluorine-containing polymer is present not only on the pellet surface but also within the pellet according to its concentration. Therefore, it is considered that in the course of molding the resin composition of the invention, particularly after initiation of melting of the pellets or the like, the fluorine-containing polymer migrates out from inside of the pellet to reduce interactions between molecules of the engineering plastic and between segments of the molecule and thereby prevents blocking, thus facilitating the transport of the engineering plastic and hence the resin composition comprising the engineering plastic through the extruder. Accordingly, the extrusion torque and extrusion pressure are reduced as a consequence, thus contributing to improved molding processability.

The resin composition of the invention, particularly when it is a powdery blend, may be subjected to size selection, where necessary.

The resin composition of the invention may be of any desired form, for example, a powder, granules or pellets.

The resin composition of the invention, thus obtained, can be used as a molding material.

The method of producing a shaped article according to the present invention employs the above described resin composition.

The method of producing a shaped article comprises charging a molding machine, such as a screw extruder, with the resin composition. The production procedure after feeding to a molding machine is not particularly limited insofar as it is heat-melt molding. Thus, for example, a conventional process can be used which comprises heating the resin composition fed to a screw extruder or the like molding machine as above to a predetermined molding temperature, with pressure applied where necessary, and molding such as extrusion of the melted resin composition to the die of the molding machine or injection thereof to the mold to obtain an article of the desired shape.

In the above molding method, the resin composition of the invention is melted in the heating zone within the molding machine and molded as it departs from the heating zone and enters into the cooling zone. In this process, the resin composition of the invention is conducive to stable transport of the melt from the heating zone to the cooling zone, thus contributing to improved molding processability.

In the resin composition of the invention, as mentioned above, the particles comprising the fluorine-containing polymer adhere to the surface of pellets, for example, of the engineering plastic almost uniformly. Therefore, it may be considered that the particles melt preceding to the melting of the engineering plastic by heating in the molding machine. The fluorine-containing polymer, as mentioned above, tends to melt before the engineering plastic with higher probability, in the case that the polymer is in the form of a powder and/or has a melting point lower than that of the engineering plastic. Therefore, the fluorine-containing polymer can exhibit its lubrication effect sufficiently in the molding machine.

The heating zone in the molding machine, taking an extruder as an example, typically is a melt-extrusion zone, which is usually equipped with a screw and a barrel, and is designed such that a resin composition in the barrel is heated by heaters disposed around the barrel.

The improved molding processability with an extruder, for instance, is attained as the extrusion torque and extrusion pressure are significantly reduced. Thus, depending on the formulation of the resin composition and the molding conditions, in extrusion molding, for instance, the extrusion torque can be reduced to 20˜80% of the level prevailing in the event of omission of the fluorine-containing polymer from the formulation. Also, the extrusion pressure can be reduced to 40 to 90% of the level prevailing in the absence of the fluorine-containing polymer.

The specific technique for producing the shaped article is not particularly limited but includes extrusion molding, injection molding, blow molding, casting (with a metal mold), rotary molding and the like. Extrusion molding is preferred, however, so that the improved effect on molding processability may be more effectively expressed.

The various extruder operating parameters for use in the above technology of producing a shaped article are not particularly limited but may be those conventionally used. The molding temperature is typically a temperature higher than the melting point of the engineering plastic. The molding temperature, when within the above-mentioned range, is typically a temperature below the lower of the decomposition temperature of the fluorine-containing polymer and that of the engineering plastic. Such temperature includes, for example, 250 to 400° C. The molding temperature is sometimes referred to as the extrusion temperature in the case of extrusion molding.

The shaped article obtained by the above molding technology is not particularly limited but includes articles having various configurations or geometries, for example, various sheaths, ribbons or filaments; sheets; films; rods; pipes; and the like.

The use of the shaped article is not particularly limited, but the invention can be applied with advantage to product fields particularly calling for critical mechanical and other dynamic properties and high heat resistance, depending on the kind of engineering plastic that is used. Thus, the shaped article includes but is not limited to space and other machines or devices; machine parts such as gears and cams; electric/electronic parts such as connectors, plugs, switches, enamels for conductor use, etc.; automobiles, aircraft and other vehicles and their component parts; decorative sheets; magnetic tapes, photographic film, gas separating membrane and other films; optical products such as lenses, compact disks, substrates for optical disks, optical fibers, safety goggles, etc.; beverage bottles and other food containers; various heat-resisting medical devices and supplies; and other industrial parts.

### EFFECT OF THE INVENTION

The resin composition of the invention is prepared by formulating the fluorine-containing polymer in a defined content range and, as such, is conducive to good and stable transport of the melt from the heating zone to the cooling zone of a molding machine, enabling stable production with improved yield and higher productivity of shaped articles and favoring industrial-scale production of engineering plastic products.

The mechanism of the resin composition in providing such favorable results is not fully clear but it seems chiefly attributable to the fact that, in the course of transport of the resin melt from the heating zone to the cooling zone, the fluorine-containing polymer acts as a lubricant across the interface between the internal wall of the molding machine and the resin melt coming into contact therewith. The fluorine-containing polymer in extrusion molding is considered to exert such a lubricating action on surfaces of a revolving screw and a surrounding extruder barrel.

The fluorine-containing polymer exhibiting such a lubricating action may be a molten entity such as FEP in the melt and the molding temperature is selected to be higher than the melting point of FEP; or a non-molten entity such as PTFE in the melt and a molding temperature is selected to be lower than the melting-start point of PTFE. When the fluorine-containing polymer is one which is in a molten state at the molding temperature, it is preferably a polymer not compatible with the engineering plastic so that the above lubricating action may be effectively expressed.

With the resin composition of the invention, it is often unnecessary to make a critical selection in regard to the relationship of melting point to molding temperature, for instance, with the result that the fluorine-containing resin can be selected from among a broad variety of polymers, thus broadening the freedom of choice for materials.

The lubricating action of the resin composition of the invention can be obtained by formulating the fluorine-containing polymer in a small amount within the above-mentioned range. Thus, the resin composition of the invention is of great industrial value in that it helps to improve the moldability of engineering plastics on a high production scale in a simple manner. Also, despite the generally high cost of the fluorine-containing polymer, the expected effect can be obtained with a small amount of the polymer as mentioned above.

### EXAMPLES

The following examples are intended to describe the present invention in further detail and should by no means be construed as defining the scope of the invention. It should also be understood that the formulating amount (mass %) of the fluorine-containing polymer is based on the total amount of the fluorine-containing polymer and the engineering plastic combined.

Example of Synthesis-1

Synthesis of an FEP Copolymer

A 1000-L glass-lined vertical autoclave equipped with a stirring means was charged with 270 kg of pure water and 0.1 kg of ammonium ω-hydroxyfluorocarboxylate and subjected to 3 cycles of nitrogen purging and vacuum degassing. Then, the autoclave was further charged with 233 kg of hexafluoropropylene (HFP) and 2.3 kg of perfluoro(propyl vinyl ether) (PPVE) under vacuum.

The stirrer was started and the temperature of the polymerization vessel was set to 29.0° C. Then, tetrafluoroethylene (TFE) was introduced to increase the pressure to 0.9 MPaG. The autoclave was further charged with 3.8 kg of di(ω-hydrodecafluoroheptanoyl) peroxide (DHP) diluted to about 8 wt % with perfluorohexane, whereupon the reaction began immediately.

During this reaction, the system was supplemented with TFE and the internal pressure of the autoclave was maintained at 0.9 MPaG. After 9, 18 and 27 hours of reaction, PPVE was further added in 0.5 kg portions each, and after 3, 8 and 13 hours of reaction, DHP was further added in 3.8 kg portions each. Moreover, after 18, 23, 28 and 33 hours of reaction, DHP was further added in 1.9 kg portions each. Furthermore, for molecular weight control, 1.7 kg of the chain transfer agent methanol was added at 5 hours after the start of reaction. The reaction was carried out for 37 hours and the unreacted TFE and HFP were driven off to give a granular powder. To this powder was added pure water, and after washing with stirring, the powder was taken out of the autoclave. The powder was dried at 150° C. for 24 hours to recover 333 kg of the objective FEP copolymer.

The TFE:HFP:PPVE weight ratio of the copolymer as analyzed with NMR analyzer was 86.6:12.5:0.9.

(Determination of Polar Functional Group Content)

A 0.1 mm-thick polymer film obtained by compression-molding the above FEP copolymer at 300° C. was scanned with a FTIR spectrophotometer to determine the absorbance. The number of end groups per 10⁶ carbon atoms was calculated by means of the following equation.

(the number of polar functional groups per 10⁶ carbon atoms)=(absorbance)×(CF)×(thickness of polymer film)⁻¹

As a result, any such polar functional groups was detected only in a trace amount at the chain terminus; thus five —COOH groups per 10⁶ carbon atoms and no polar functional groups were found.

(Measurement of Melt Flow Rate (MFR))

In accordance with ASTM D 1238-00(2000), using a KAYNESS melt index tester (Model 4002), about 6 g of the FEP copolymer obtained above was placed in a 0.376-inch (in. dia.) cylinder maintained at 37.2°±0.5° C. and allowed to stand for 5 minutes. After the temperature had reached equilibrium, the resin was extruded through an orifice, 0.0825 inch in diameter×0.315 inch long, under a piston load of 5000 g and the weight (g) of the resin recovered in a unit time of 10 seconds was determined. Data from three runs were averaged and converted to the extrusion amount per 10 minutes and designated as MFR (unit: g/10 min). The MFR value thus found was 23.5 g/10 min.

Example of Synthesis-2

Synthesis of an FEP Copolymer

Except that PPVE was omitted, the procedure of Example of Synthesis-1 was repeated to give a FEP copolymer. The TFE:HFP weight ratio was 86.3:13.7 and the MFR value was 18.5 g/10 min.

Example of Synthesis-3

Synthesis of a Low-Molecular-Weight PTFE

A 100-L stainless steel (SUS316) autoclave equipped with a stainless steel (SUS316) anchor type stirring impeller and a temperature control jacket was charged with 54 L of deionized water and 11.6 g of ammonium perfluorooctanoate, and the internal atmosphere of the autoclave was replaced with nitrogen gas three times and TFE gas twice under warming at 55° C. to remove oxygen. Then, the autoclave was charged with 330 g of CH₃Cl and the internal pressure was adjusted to 0.83 MPaG with TFE gas. The stirring was carried out at 80 rpm and the internal temperature was maintained at 55° C.

Then, a solution of 14.3 g of ammonium persulfate in 1 L of water was introduced under pressure with TFE to adjust the internal pressure of the autoclave to 0.88 MPaG for accelerating the reaction. During this time, the reaction temperature was maintained at 55° C. and the stirring speed at 80 rpm. TFE was continuously supplied so that the internal pressure of the autoclave would be consistently maintained at 0.88±0.05 MPaG. When 10.3 kg of TFE had been consumed, the agitation and monomer feeding were stopped and the gas within the autoclave was released down to atmospheric pressure to terminate the reaction. The total reaction time was 5.3 hours. The polymer concentration of the resulting latex was 15.8 wt % and the number average particle diameter of the polymer was 0.18 μm.

This latex was coagulated and washed, and the resulting polymer powder was dried at 150° C. for 18 hours. The melt viscosity of the powder at 380° C. was 2.0×10⁵ poises, the melting point was 327° C., and the number average particle diameter was 5 μm.

### Example 1

The FEP copolymer obtained by Example of Synthesis-1 was formulated, in a proportion of 0.05 mass %, with nylon 66 (product name: Zytel-42, product of E. I. du Pont de Nemours and Company) and these materials were blended using a paint shaker and molded using an extrusion molding machine (Model RCP-0625, Microtruder, screw size: ⅝ inch, LD: 24/1, sheet die width: 6 inches; manufactured by Randcastle Extrusion Systems, Inc.) at a screw rotational speed of 60 rpm and an extrusion temperature of 280° C. The extrusion torque, extrusion pressure, and extrusion speed are shown in Table 1.

### Example 2

Except that the screw speed was set to 80 rpm, the molding operation of Example 1 was otherwise faithfully repeated. The extrusion torque, extrusion pressure, and extrusion speed are shown in Table 1.

### Example 3

Except that as FEP copolymer used was obtained by Example of Synthesis-2, the molding procedure of Example 1 was otherwise faithfully repeated. The extrusion torque, extrusion pressure, and extrusion speed are shown in Table 1.

### Example 4

Except that the low molecular weight PTFE obtained by Example of Synthesis-3 was used in lieu of the FEP copolymer, the molding procedure of Example 1 was otherwise faithfully repeated. The extrusion torque, extrusion pressure, and extrusion speed are shown in Table 1.

### Example 5

Except that Celanex 1200 (product of Hoechst-Celanese) was used in lieu of Zytel-42 as nylon 66, the molding procedure of Example 1 was otherwise faithfully repeated. The extrusion torque, extrusion pressure, and extrusion speed are shown in Table 1.

### Example 6

Except that nylon 46 (trade name: Stanyl 441, product of DSM Engineering Plastics, Inc.) was used in lieu of nylon 66 and the screw speed and extrusion temperature were set to 72 rpm and 281° C., respectively, the molding procedure of Example 1 was otherwise faithfully repeated. The extrusion torque, extrusion pressure, and extrusion speed are shown in Table 1.

### Example 7

Except that the low-molecular-weight PTFE obtained by Example of Synthesis-3 in lieu of FEP copolymer was formulated in a proportion of 0.025 mass %, the molding procedure of Example 6 was otherwise faithfully repeated. The extrusion torque, extrusion pressure, and extrusion speed are shown in Table 1.

### Examples 8 and 9

The molding procedure of Example 1 was repeated, except that the low-molecular-weight PTFE obtained by Example of Synthesis-3 was formulated in the proportions indicated in Table 1, that PEEK (trade name: PEEK 450, product of ICI Victrex Corp.) was used in lieu of nylon 66, and that the screw speed and extrusion temperature were set to 72 rpm and 360° C., respectively. The extrusion torque, extrusion pressure, and extrusion speed are shown in Table 1.

### Comparative Examples 1 to 9

Except that no fluorine-containing polymer was added, the molding procedures described in Examples 1 to 9 were otherwise faithfully repeated. The extrusion torque, extrusion pressure, and extrusion speed are shown in Table 1.

TABLE 1

| | | Comp. | Comp. | Comp. | Comp. | Comp. | | | | |
|---|---|---|---|---|---|---|---|---|---|---|
| | | Ex. 1 | Ex. 2/ | Ex. 3/ | Ex. 4/ | Ex. 5/ | Comp. Ex. 6/ | Comp. Ex. 7/ | Comp. Ex. 8/ | Comp. Ex. 9/ |
| | | Ex. 1 | Ex. 2 | Ex. 3 | Ex. 4 | Ex. 5 | Ex. 6 | Ex. 7 | Ex. 8 | Ex. 9 |
| Fluorine- | FEP of Ex. | 0.05 | 0.05 | — | — | 0.05 | 0.05 | — | — | — |
| containing | Syn.-1 | | | | | | | | | |
| polymer (% | FEP of Ex. | — | — | 0.05 | — | — | — | — | — | — |
| level of | Syn.-2 | | | | | | | | | |
| addition) | Low-molecular- | — | — | — | 0.05 | — | — | 0.025 | 0.025 | 0.05 |
| | wt. PTFE of | | | | | | | | | |
| | Ex. Syn.-3 | | | | | | | | | |

| | | | | | | | | | |
|---|---|---|---|---|---|---|---|---|---|
| Engineering plastic | Zytel | Zytel | Zytel | Zytel | Celanex | Stanyl | Stabyl | PEEK | PEEK |
| Screw speed (rpm) | 60 | 80 | 60 | 60 | 60 | 72 | 72 | 72 | 72 |
| Extrusion temperature (° C.) | 280 | 280 | 280 | 280 | 280 | 281 | 281 | 360 | 360 |
| Extrusion torque* (amp) | 6.5/1.5 | 7.2/2.1 | 5.5/1.8 | 6.1/2.8 | 6.2/1.9 | 4/2 | 4/2.2 | 4/2.6 | 4.1/2 |
| Extrusion pressure* (psi) | 601/320 | 670/380 | 570/300 | 605/345 | 605/300 | 355/270 | 355/250 | 930/730 | 930/750 |
| Extrusion speed* (g/min) | 20/22 | 24/25 | 20/22 | 20/17 | 20/21 | 15/17 | 15/− | −/− | −/− |

*The FIG. at left represents no addition of a fluorine-containing polymer and the FIG. at right represents addition of a fluorine-containing polymer.

It is clear from Table 1 that, when a nylon or PEEK was used as the engineering plastic, the extrusion torque and extrusion pressure were reduced significantly in the Examples of the invention, where any of FEP copolymer and low-molecular-weight PTFE, as the fluorine-containing polymer, was formulated in a mass ratio of the engineering plastic to fluorine-containing polymer within the range of 99:1 to 99.995:0.005, as compared with Comparative Examples where no fluorine-containing polymer was added.

It should further be apparent to those skilled in the art that various changes in form and detail of the invention as shown and described above may be made. It is intended that such changes be included within the spirit and scope of the claims appended hereto.

What is claimed is:

1. A resin composition prepared by formulating an engineering plastic with a fluorine-containing polymer in a mass ratio of the engineering plastic to the fluorine-containing polymer of from 99:1 to 99.995:0.005.

2. The resin composition as claimed in claim 1, wherein the fluorine-containing polymer contains tetrafluoroethylene units.

3. The resin composition as claimed in claim 1, wherein the fluorine-containing polymer comprises a perfluoropolymer.

4. The resin composition as claimed in claim 1, wherein the fluorine-containing polymer has substantially no functional groups that react with the engineering plastic.

5. The resin composition as claimed in claim 1, wherein said engineering plastic comprises a polyamide.

6. The resin composition as claimed in claim 1, wherein said engineering plastic comprises a polyetheretherketone.

7. The resin composition as claimed in claim 1, for use as a molding material.

8. A method for producing resin composition as claimed in claim 1, which comprises formulating an engineering plastic with a fluorine-containing polymer in a mass ratio of the engineering plastic to the fluorine-containing polymer of from 99:1 to 99.995:0.005.

9. A method for producing a shaped article which comprises providing a resin composition prepared by formulating an engineering plastic with a fluorine-containing polymer in a mass ratio of the engineering plastic to the fluorine-containing polymer of from 99:1 to 99.995:0.005; and melting and molding the resin composition.

10. The method for producing a shaped article as claimed in claim 9, which comprises molding at a temperature not lower than the melting point of the engineering plastic.

11. The method for producing a shaped article as claimed in claim 9, wherein the fluorine-containing polymer has a melting point not higher than that of the engineering plastic.
